(19) United States
(12) Patent Application Publication
(10) Pub. No.: US 2010/0154188 A1
(43) Pub. Date: Jun. 24, 2010

(54) Method For Securing A Heat Exchanger Bracket

(75) Inventors: Don Clair Corser, Lockport, NY (US); Joel Thomas Hambruch, Burt, NY (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: Delphi Technologies, Inc., Troy, MI (US)

(21) Appl. No.: 12/339,425

(22) Filed: Dec. 19, 2008

(51) Int. Cl. B23P 19/00

(52) U.S. Cl. 29/426.1

(57) ABSTRACT

A method for attaching a bracket to a heat exchanger comprises providing a heat exchanger having a mounting surface. A bracket having an edge portion that conforms to the mounting surface is located in contact with the mounting surface. A portion of the mounting surface is then skived with the bracket in place so that a sufficient amount of skived material is deformed against the edge portion of the bracket to retain the bracket to the heat exchanger. The retained bracket is then brazed to the heat exchanger.

### TECHNICAL FIELD OF INVENTION

The invention relates to heat exchanger assemblies, particularly to a method for temporarily securing a bracket to a heat exchanger until the bracket is permanently brazed to the heat exchanger.

### BACKGROUND OF INVENTION

Heat exchangers commonly require mounting brackets to be attached to the end manifolds and/or to the side reinforcement channels. There are several methods currently used to attach the brackets. In some cases the bracket is brazed to the heat exchanger; in other cases the bracket is attached after the brazing process. When the bracket is to be brazed to the heat exchanger, it is necessary to temporarily secure the bracket in place to the heat exchanger until the brazing process is completed.

A first known method of securing a bracket to a heat exchanger is to use screws to attach the bracket. Screws are costly and time consuming to drive. Screw attachment is normally used after the brazing process, and the screwed joint must withstand all of the applied stresses to the bracket and heat exchanger over the lifetime of the assembly.

A second known method of securing a bracket is to braze the bracket to the heat exchanger, using special fixtures to clamp the bracket to the heat exchanger through the brazing process. This method requires model-specific clamping fixtures that may be very costly.

A third known method of securing a bracket is to fixture and spot weld the bracket to the heat exchanger before brazing. This method may alter the material properties of the bracket and/or the heat exchanger, and requires skilled welding operators to affix the bracket to the heat exchanger without damaging the heat exchanger.

A fourth known method of securing a bracket to a heat exchanger is to first skive tabs into the heat exchanger, then place the bracket on the heat exchanger in the proper location relative to the skived tabs, and subsequently clinch the tabs onto the bracket to hold the assembly in place through a brazing operation. While this method can provide a self-fixtured assembly to the brazing process, it still has several associated drawbacks. Skiving is done relatively early in the process, and results in the necessity to handle a part with the skived tabs exposed. This leaves the tabs subject to damage in subsequent handling. The bracket needs to be placed over the tabs without bending or breaking the tabs, which requires adequate clearance between the bracket and the tabs as well as precise positioning of the bracket over the tabs. The requirement for adequate clearance between the bracket and the tabs results in the potential for more variation in the final location of the bracket on the heat exchanger. Additional machines and operations are required to skive the tabs, properly position the bracket over the tabs, and clinch the skived tabs to secure the joint.

What is desired is an improved method to retain a bracket to a heat exchanger until the bracket can be permanently affixed to the heat exchanger by brazing.

### SUMMARY OF THE INVENTION

The present invention is a method for attaching a bracket to a heat exchanger. In accordance with this method, a heat exchanger having a surface to which the bracket is to be mounted is provided. A bracket is placed in contact with the mounting surface at a desired mounting location. The bracket has an edge portion that conforms to the mounting surface. A subsequent operation performed with the bracket in place skives a portion of the mounting surface adjacent to the edge portion of the bracket, deforming the skived material against the edge portion of the bracket. The skived material acts to retain the bracket in place on the heat exchanger until the bracket and heat exchanger assembly can be brazed to form a permanent connection.

### BRIEF DESCRIPTION OF DRAWINGS

This invention will be further described with reference to the accompanying drawings in which:

FIG. 1 is a flow chart listing the steps of the method;

FIG. 2 is a representation of a heat exchanger assembly process according to an exemplary embodiment of this invention;

FIG. 3 is a pictorial view of a heat exchanger with a bracket affixed by skiving according to an exemplary embodiment of this invention;

FIG. 4 is a plan view of a heat exchanger with a bracket affixed by skiving according to an exemplary embodiment of this invention; and

FIG. 5 is a section view of a heat exchanger with a bracket affixed by skiving according to an exemplary embodiment of this invention.

### DETAILED DESCRIPTION OF INVENTION

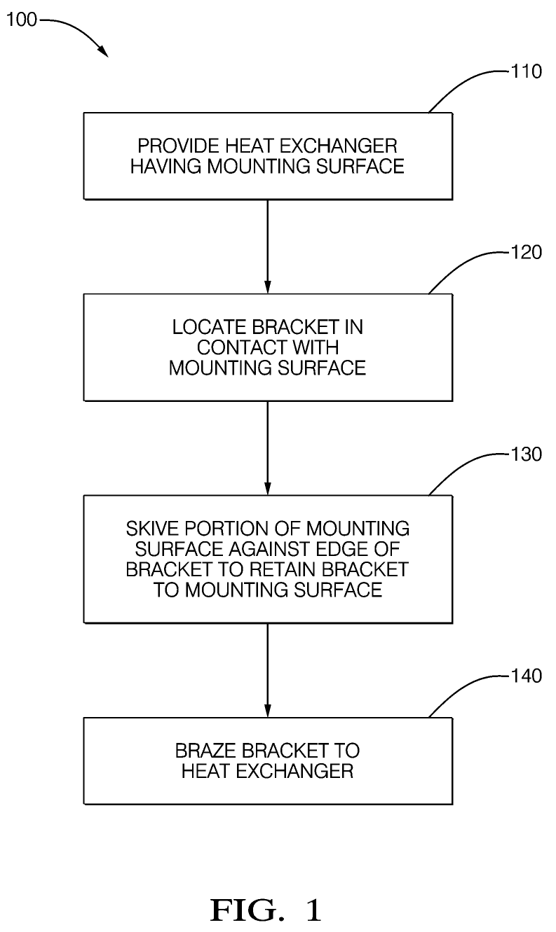

In accordance with an exemplary embodiment of this invention, referring to FIG. 1, a method 100 for securing a bracket to a heat exchanger is presented in a flow chart. In step 110, a heat exchanger is provided. The heat exchanger has a mounting surface to which the bracket is to be attached. Next, in step 120, a bracket is located in contact with the mounting surface. The bracket has an edge portion that conforms to the mounting surface so that along the edge portion the bracket is in direct contact with the mounting surface. Then, in step 130, a portion of the mounting surface is skived. The material displaced in the skiving operation is deformed against the edge portion of the bracket, thereby retaining the bracket to the heat exchanger sufficiently to maintain the relative location of the bracket to the heat exchanger until the heat exchanger and bracket can be permanently joined in a brazing operation. In step 140, the brazing operation is performed to permanently join the bracket to the heat exchanger.

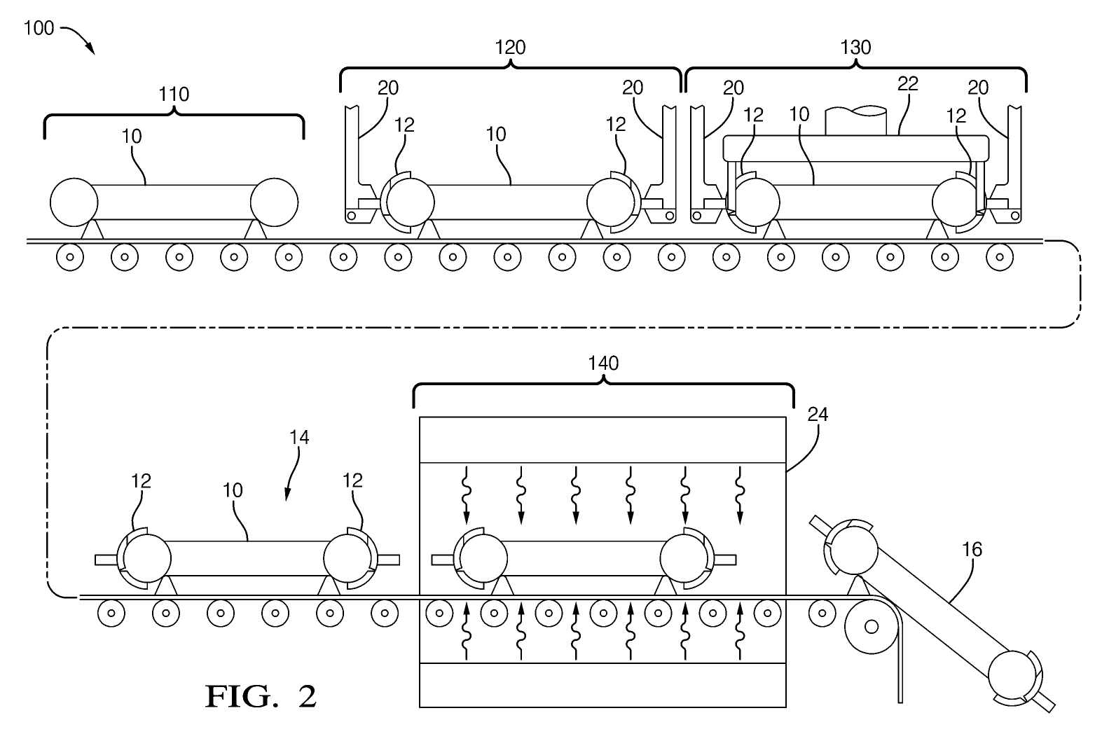

FIG. 2 is a pictorial view showing the salient features of a process for performing the method of this invention. At step 110, a heat exchanger 10 is provided. This heat exchanger 10 has a mounting surface adapted to mate with a bracket.

Still referring to FIG. 2, at step 120, bracket 12 is located on the mounting surface. Bracket 12 has an edge portion that conforms to the mounting surface of heat exchanger 10. Fixturing 20 is employed to maintain the bracket 12 to the heat exchanger 10 until the bracket is secured.

At step 130 of FIG. 2, with the bracket 12 held in place by fixturing 20, heat exchanger 10 is skived using skiving tool 22. As described earlier, the skiving operation 130 displaces material from the mounting surface of the heat exchanger 10 and deforms it against an edge of bracket 12 to retain the bracket 12 to the heat exchanger 10.

Upon completion of the skiving step 130, the heat exchanger 10 and bracket 12 comprise a skived heat exchanger/bracket assembly 14. The skived heat exchanger/bracket assembly 14 is retained sufficiently to maintain the bracket 12 to the heat exchanger 10 without the need for external fixturing 20 until brazing can be completed.

At step 140 in FIG. 2, the skived heat exchanger/bracket assembly 14 enters brazing furnace 24 where the heat exchanger 10 and bracket 12 are permanently attached by brazing. Upon completion of brazing step 140, the heat exchanger 10 and bracket 12 comprise a brazed heat exchanger/bracket assembly 16.

It is noted that the term “heat exchanger” as it applies to this method is not limited to a complete heat exchanger assembly, but may refer to a component of a complete heat exchanger assembly. For example, it may be preferred to mount a bracket to a manifold tank by skiving a portion of a mounting surface on the manifold tank according to the method of this invention before assembling the manifold tank to a heat exchanger core portion. Additionally, it is noted that the brazing operation described in step 140 of the description above may be used to concurrently braze manifold tanks to a core portion while brazing the bracket 12 to the heat exchanger.

As described above, the method of this invention includes skiving a portion of the mounting surface of the heat exchanger 10 adjacent to an edge portion of the bracket 12 so that a sufficient amount of the skived material is deformed against the edge portion to retain the bracket 12 to the heat exchanger 10. One way to accomplish this is with the edge portion comprising a portion of a peripheral edge of the bracket. In order to achieve sufficient retention of bracket 12 to heat exchanger 10, this may require skiving material from the mounting surface toward opposing peripheral edges of the bracket in two opposing directions to trap bracket 12 in place. Skiving in two opposing directions is more complex than a single direction skiving operation, and may require more complex equipment and/or additional handling of the heat exchanger/bracket assembly.

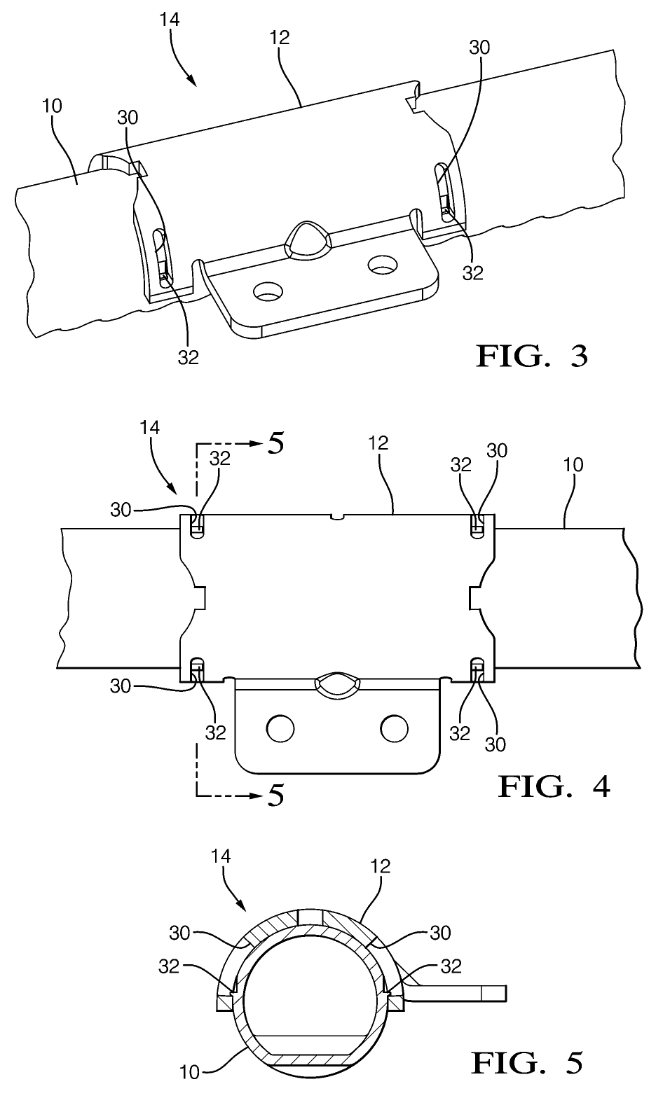

The embodiment of this invention depicted in FIG. 3, FIG. 4, and FIG. 5 eliminates the complication of skiving in opposing directions. In this embodiment, a plurality of apertures 30 are defined in bracket 12. The periphery of each aperture 30 acts as the aforementioned edge portion of bracket 12, in that material is skived from a portion of the mounting surface accessible through aperture 30 and deformed against a peripheral portion of aperture 30. The pictorial view of FIG. 3 shows a skived heat exchanger/bracket assembly 14, having a bracket 12 secured to a heat exchanger 10 with two apertures 30 visible. Skived material 32 is deformed against a peripheral edge of aperture 30 to secure the bracket 12 to the heat exchanger 10. In the plan view of skived heat exchanger/bracket assembly 14 shown in FIG. 4, four apertures 30 can be seen defined in bracket 12. FIG. 5 is a section view through two of the apertures 30 depicted in FIG. 4. As seen in FIGS. 3, 4, and 5, skived material 32 from the mounting surface of heat exchanger 10 is deformed against a peripheral edge of aperture 30, with all of the skiving operations performed from the same direction. In this manner, the bracket 12 can be secured to the heat exchanger 10 without requiring skiving operations from opposing directions. As a result, the skiving operation can be simplified in terms of fixturing, tooling, and material handling.

While this invention has been described in terms of the preferred embodiments thereof, it is not intended to be so limited, but rather only to the extent set forth in the claims that follow.

We claim:

1. A method for attaching a bracket to a heat exchanger comprising the steps of
providing a heat exchanger having a mounting surface; followed by
locating a bracket in contact with the mounting surface, the bracket having an edge portion that conforms to the mounting surface; followed by
skiving a portion of the mounting surface adjacent to the edge portion so that a sufficient amount of the skived material is deformed against the edge portion to retain the bracket to the heat exchanger.

2. The method of claim 1 further comprising the step of brazing the retained bracket to the heat exchanger.

3. The method of claim 1 wherein the edge portion is the periphery of an aperture defined in the bracket, and skiving is performed on a portion of the mounting surface accessible through the aperture.

4. The method of claim 3 wherein material is skived against edge portions of a plurality of apertures defined in the bracket.

5. The method of claim 4 wherein the bracket is retained by skived material wherein the skiving through all of the plurality of apertures is performed in the same direction.
